(19) United States
(12) Patent Application Publication
(10) Pub. No.: US 2011/0183681 A1
(43) Pub. Date: Jul. 28, 2011

(54) METHOD AND APPARATUS FOR THE MOBILITY MANAGEMENT OF A MOBILE TERMINAL BASED ON CELL-CLUSTER IN MOBILE COMMUNICATIONS NETWORKS

(76) Inventors: Jin Woo Park, Seoul (KR); Young Min Jo, Seoul (KR)

(21) Appl. No.: 12/667,039

(22) PCT Filed: Dec. 13, 2007
(86) PCT No.: PCT/KR07/06515

§ 371 Date: Nov. 26, 2010

(30) Foreign Application Priority Data
Jun. 26, 2007 (KR) 10-2007-0063204

(51) Int. Cl. H04W 64/00

(52) U.S. Cl. 455/456.1; 455/517

(57) ABSTRACT

The present invention relates to a method and apparatus which is capable of managing movement of a mobile terminal in the unit of cell cluster in a mobile communication system. The method includes the steps of: forming cell clusters each including at least one cell including a base station communicating with the mobile terminal; determining a position of the mobile terminal; and if it is determined that the mobile terminal moves from one cell cluster to another cell cluster, changing location information of the mobile terminal. According to the present invention, it is possible to overcome a drawback of a conventional mobile communication system which is difficult to manage movement of a mobile terminal due to indistinctness or overlapping of cell or wireless communication areas, and thus achieve efficient and economical mobile terminal mobility management.

### TECHNICAL FIELD

The present invention relates to a method and apparatus which is capable of managing mobility of a mobile terminal in the unit of cell cluster in a mobile communication system.

### BACKGROUND ART

Today, with popularization of mobile communication services using a carrier wave of 1 to 2 GHz, mobile communication systems have developed into advanced next generation mobile communication systems for the purpose of providing more diversified wireless multimedia services to more number of subscribers.

In a conventional mobile communication system, a mobile communication service area is divided into smaller areas called cells in each of which a base station having a transmit-receive antenna is located. The base station performs wireless transmit-receive communications with mobile terminals located in the cells. A size of cell radius in a current mobile communication system using a carrier wave of a band of 1 to 2 GHz is about 1 to 3 km. The cell base stations are connected to a mobile communication switching center which functions as a connection point to an external communication network and supports a handover so that a wireless communication service can be provided without disconnection when a mobile terminal moves from one cell to another cell.

Since the carrier wave band of 1 to 2 GHz used in the current mobile communication service is rapidly exhausted due to the expanding mobile communication services, necessity of utilizing a carrier wave at a higher frequency, for example, more than 3 GHz, is on the rise. Such a carrier wave at the higher frequency has an electromagnetic wave propagation characteristic which is greatly different from that of the existing carrier waves. That is, the carrier wave having the higher frequency is significantly reduced in its effective propagation distance resulting into a greatly decreased communications-enabling zone due to a higher scattering effect caused by substances present in air and a lower diffraction and reflection effects which enables wireless connection even at the shadow area having no line-of-sight direct connection path. For this reason, the cell diameter of the mobile communication systems using the carrier wave at the higher frequency can be significantly reduced, approximately to several tens to several hundreds meter. It consequently requires an increased number of cells to provide the same quality of wireless connectivity. Such a small cell is called a micro-cell or a pico-cell.

In particular, the line-of-sight propagations are frequently blocked by various structures such as buildings, advertizing boards, etc. in a metropolitan area, which causes many wireless-communication shadow regions. To overcome this problem, even many transmit-receive antennas and base stations are required to be installed.

In particular, in addition to reduction of the size of cell, it becomes difficult to distinguish between cell areas established as wireless communication areas covered by one transmit-receive antenna and thus avoid overlapping of the cell areas. Under such radio environments, when a mobile terminal moves from one cell to another adjacent cell, a handover is more frequently generated in a mobile communication system that manages mobility of the mobile terminal in the unit of cell as conventional. This requires higher performance of a mobile communication switching center and significantly reduces efficiency of a cell-based handover control method due to indistinctness of cell areas.

In a wireless communication LAN (Local Area Network) system, studies on method of providing continuous communication services to moving mobile terminals have been made. Considering that wireless LANs are mainly utilized indoors, since the wireless LANS depend mainly on line-of-sight (LOS) communication, it is greatly difficult to manage a mobility using an AP (Access Point) as a wireless access point. That is, a communication area of AP is affected by facilities and structures such as walls, furniture and so on, which may result in irregularity and limitation of a size of the communication area. In order to overcome this problem, a number of APs are required to be installed, which leads to unavoidable overlapping of AP communication areas and difficulty in mobility management. In the end, in order to realize a continuous mobile communication service for mobile terminals according to a handover scheme as in a wireless mobile communication system, there is a need of a mobility management system which is capable of defining AP communication areas and efficiently managing a handover between the AP communication areas.

As a result, since existing mobile handover management systems operating based on the unit of cell or communication area as in the next generation mobile communication system and a wireless LAN communication system using a high carrier frequency is very difficult or complicated to provide a continuous wireless communication service, there is a need of a novel efficient mobility management method which is capable of improving the existing mobile handover management systems.

### DISCLOSURE OF INVENTION

### Technical Problem

To overcome the above problem, it is an object of the present invention to provide a cell cluster area-based mobility management method which is capable of efficiently managing mobility of mobile terminals in the next generation mobile communication system and a wireless LAN system using a high carrier frequency by defining adjacent cells by a cell cluster and managing the mobility of the mobile terminals in the unit of cell cluster such that continuous communication services can be provided to the mobile terminals while they are moving, and a structure of a wireless subscriber network to support the same method.

### Technical Solution

To achieve the above object, according to an aspect, the present invention provides a method of managing movement of a mobile terminal in the unit of cell cluster in a mobile communication system, including the steps of: forming cell clusters each including at least one cell including a base station communicating with the mobile terminal; determining a position of the mobile terminal in the unit of cell cluster; and if it is determined that the mobile terminal moves from one cell cluster to another cell cluster, changing location information of the mobile terminal.

Preferably, the method further includes the steps of: receiving uplink signals of the mobile terminal from at least one base station that received the uplink signal of the mobile terminal; forming a cluster signal by adding the received uplink signals; and transmitting the cluster signal to an upper node. Preferably, the method further includes the step of: compensating a difference between signal propagation time delays of the uplink signals due to a difference between distances between the base stations and a mobile communication switching center.

Preferably, communication with the mobile terminal is performed using a cluster signal of the changed cell cluster. Preferably, the cell clusters are dynamically formed according to the movement of the mobile terminal or change of environments of communication with the mobile terminal.

Preferably, the method further includes the steps of: receiving a downlink signal of the mobile terminal from an upper node; separating the downlink signal for each of one or more base stations communicating with the mobile terminal; and transmitting the separated signals to the one or more base stations, respectively, wherein the one or more base stations transmit the separated signals to the mobile terminal.

According to another aspect of the present invention, there is provided a mobile communication system that manages movement of a mobile terminal in the unit of cell cluster, including: a mobile terminal; one or more base stations that communicates with the mobile terminal; and a mobile communication switching center that forms cell clusters each including at least one cell including the base stations and manages the movement of the mobile terminal in the unit of cell cluster.

Preferably, the mobile communication switching center generates a cell cluster signal by adding uplink signals of the mobile terminal, which are received from the base stations, and transmits the cell cluster signal to an upper node. Preferably, the mobile communication switching center compensates a difference between signal propagation time delays of the uplink signals due to a difference between distances between the base stations and the mobile communication switching center before generating the cell cluster signal by adding the uplink signals. Preferably, the mobile communication switching center changes cell cluster position information of the mobile terminal when the mobile terminal moves from one cell cluster to another cell cluster. Preferably, the mobile communication switching center communicates with the mobile terminal using a cluster signal of the changed cell cluster. Preferably, the mobile communication switching center dynamically forms the cell clusters according to the movement of the mobile terminal or change of environments of communication with the mobile terminal.

According to still another aspect of the present invention, there is provided a mobile communication switching center that communicates with a mobile terminal through one or more base stations included in cell clusters and manages the base stations in the cell clusters, including: one or more time delay compensators that compensate time delays of uplink signals of the mobile terminal, which are received from the base stations; and one or more signal adders that generate a cluster signal by adding the uplink signals which are time delay-compensated by the time delay compensators, wherein the mobile communication switching center communicates with the mobile terminal using the cluster signal.

### Advantageous Effects

The present invention provides a method of defining cell clusters each including adjacent cells and managing mobility of a mobile terminal in the unit of cell cluster in order to improve efficiency of a conventional mobile terminal mobility management method in the unit of cell or wireless communication area in the next generation communication system or the wireless LAN system using a high carrier frequency. According to the present invention, it is possible to overcome a drawback of the conventional mobile terminal mobility management method which is difficult to manage the mobility of the mobile terminal in the unit of cell due to indistinctness or overlapping of cell or wireless communication areas, and realize an efficient and economical mobile terminal mobility management system.

### BRIEF DESCRIPTION OF THE DRAWINGS

FIG. 1 is a view illustrating a method of forming cell clusters by grouping adjacent cells in a mobile communication system according to a preferred embodiment of the present invention.

FIG. 2 is a view illustrating an exemplary method of dynamically forming cell clusters according to another preferred embodiment of the present invention.

FIG. 3 is a view illustrating a configuration of a mobile communication system to manage mobility of mobile terminals in the unit of cell cluster according to a preferred embodiment of the present invention.

FIG. 4 is a view illustrating an uplink signal processing procedure in a mobile communication switching center according to a preferred embodiment of the present invention.

FIG. 5 is an exemplary view of a mobile terminal position information management database maintained by a mobile communication switching center to manage mobility of mobile terminals based on cell clusters according to a preferred embodiment of the present invention.

FIG. 6 is a view showing a case where a mobile terminal moves in one cell cluster according to a preferred embodiment of the present invention.

FIG. 7 is a view showing a case where a mobile terminal moves from one cell cluster to another adjacent cell cluster according to a preferred embodiment of the present invention.

FIG. 8 is a flow chart illustrating a process of managing mobility of a mobile terminal in a mobile communication switching center when the mobile terminal moves according to a preferred embodiment of the present invention.

### BRIEF DESCRIPTION OF REFERENCE NUMERALS

101: Mobile communication switching center

401-407: Time delay compensator

410, 420: Signal adder

### BEST MODE FOR CARRYING OUT THE INVENTION

Hereinafter, preferred embodiments of the present invention will be described in detail with reference to the accompanying drawings. In the following detailed description of the present invention, concrete description on related functions or constructions will be omitted if it is deemed that the functions and/or constructions may unnecessarily obscure the gist of the present invention.

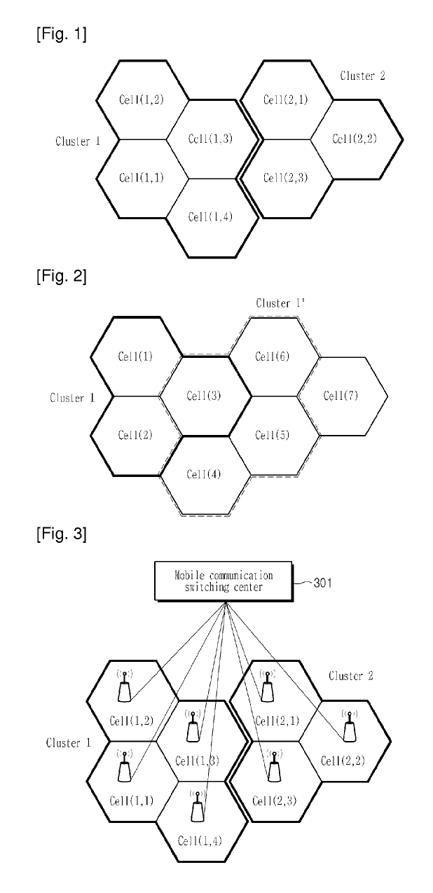

FIG. 1 is a view illustrating a method of forming cell clusters by grouping adjacent cells in a mobile communication system according to a preferred embodiment of the present invention.

Referring to FIG. 1, a cluster 1 includes a cell (1,1), a cell (1,2), a cell (1,3) and a cell (1,4), a cluster 2 includes a cell (2,1), a cell (2,2) and a cell (2,3), and a cluster 3 includes a cell (3,1), a cell (3,2) and a cell (3,3). These cells mean cells defined in a mobile communication system, or wireless communication service areas defined by one connection antenna in an indoor wireless communication system such as a wireless LAN. That is, these cells include base stations to perform radio communication with mobile terminals or wireless access devices such as APs, and areas where the base stations or the wireless access devices provide communication services to the mobile terminal become cell areas.

One cell cluster includes one or more cells and cell clusters need not to have the same number of cells. Such a cell cluster configuration may be predetermined in the process of design of a wireless subscriber network in consideration of propagation environments of a radio communication service area and installation conditions of antenna base stations or antenna units. A position of a mobile terminal is determined by one or more cells receiving a signal from the mobile terminal, which has strength larger than a predetermined threshold, and a mobile communication switching center manages the position of the mobile terminal with a cell cluster including the corresponding cell and utilizes the position of the mobile terminal for signal transmission and reception between the mobile terminal and the antenna base station. That is, although position of a mobile terminal has been managed in the unit of cell in conventional mobile communication system, the position of the mobile terminal is managed in the unit of cell cluster in the present invention.

FIG. 2 is a view illustrating an exemplary method of dynamically forming cell clusters according to another preferred embodiment of the present invention. Although FIG. 1 suggests a method of predetermining cell clusters in consideration of cell cluster propagation environments, FIG. 2 illustrates a method of dynamically forming cell clusters depending on propagation environments at which a mobile terminal is located.

Referring to FIG. 2, while a mobile communication switching center forms cell clusters with cells receiving a signal from a mobile terminal, which has strength larger than a predetermined threshold, a combination of cell clusters is changed when the mobile terminal moves. This figures shows a state where an initially set cell cluster 1 [cell (1), cell (2) and cell (3)] is changed to a cell cluster 1 [cell (3), cell (4), cell (5) and cell (6)] according to movement of the mobile terminal. That is, one cell cluster is formed for one mobile terminal and a mobile communication switching center manages cell cluster information and perform transmit-receive communication between the mobile terminal and a base station based on this information. In the following description, a method of forming a cell cluster in advance based on FIG. 1 will be described.

FIG. 3 is a view illustrating a configuration of a mobile communication system to manage mobility of mobile terminals in the unit of cell cluster according to a preferred embodiment of the present invention.

Referring to FIG. 3, a mobile communication system in the unit of cell cluster includes cell clusters, each of which is a set of cells including respective base stations, and a mobile communication switching center 301 to manage the base stations of the cells. Although not shown, the mobile communication system may further include a base station controller to control mobile terminals and the base stations. The mobile terminals and the base station controller have the same functions as those in a typical mobile communication system, and therefore, explanation of which will be omitted.

As shown and described with reference to FIGS. 1 and 2, the cell clusters of the present invention each include one or more cells and are not required to have the same number of cells. In the example of FIG. 3, a cluster 1 includes a cell (1,1), a cell (1,2), a cell (1,3) and a cell (1,4) and a cluster 2 includes a cell (2,1), a cell (2,2) and a cell (2,3).

The mobile communication switching center 301, which may be a MSC (Mobile Switching Center) in case of a CDMA network, is coupled to an upper node to allow a mobile terminal to communicate with another mobile terminal. Here, the upper node may be an exchanger or other mobile communication network to manage other terminals to communicate with the mobile terminal. In addition, the mobile communication switching center 301 is coupled to a base station located in each cell via a private communication line such as E1, T1 or the like.

In the meantime, the mobile communication switching center is coupled to a location register for registration of location of the mobile terminal. For example, the location register may be a HLR (Home Location Register) or a VLR (Visitor Location Register). The mobile communication switching center performs location registration and handover in the unit of cell for mobile terminals in conventional mobile communication system, however, in the present invention, the mobile communication switching center 310 performs location registration and handover of the mobile terminals in the unit of cell cluster.

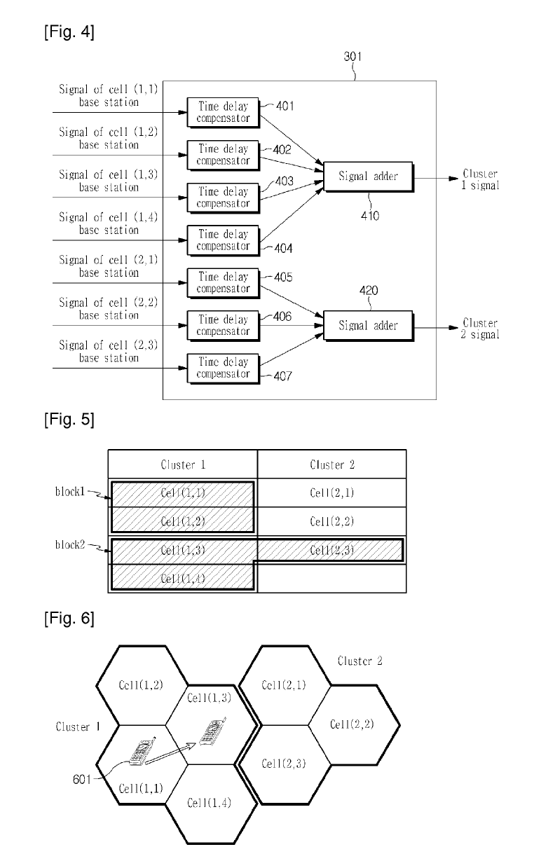

FIG. 4 is a view illustrating an uplink signal processing procedure in the mobile communication switching center according to a preferred embodiment of the present invention.

Referring to FIG. 4, the mobile communication switching center 301 includes time delay compensators 401, 402, 403, 404, 405, 406 and 407 and signal adders 410 and 420. The time delay compensators 401, 402, 403, 404, 405, 406 and 407 are in one-to-one correspondence with cell base stations managed by the mobile communication switching center 301. Since distances between the cell base stations and the mobile communication switching center 301 that manages the cell base stations are different from each other, an uplink signal of a mobile terminal arrives at the mobile communication switching center 301 with a time delay corresponding to a signal transmission distance. Therefore, the mobile communication switching center 301 constructs a cluster signal by time delay-compensating signals received from cell base stations belonging to a particular cluster by means of the time delay compensators 401, 402, 403, 404, 405, 406 and 407 and then adding the time delay-compensated signals by means of the signal adders 410 and 420.

For example, when a certain mobile terminal located in the cell (1,1) sends out an uplink signal, the mobile communication switching center 301 receives uplink signals from the cell (1,1), the cell (1,2), the cell (1, 3) and the cell (1,4). Thereafter, the mobile communication switching center 301 compensates time delay of the uplink signals received from the cells in consideration of the distances from the base stations located in the respective cells. Thereafter, the mobile communication switching center 301 generates a cluster 1 signal by adding the uplink signals time delay-compensated by the signal adder 410. When the mobile communication switching center 301 delivers the cluster 1 signal to an upper node, the mobile terminal can communicate with a counterpart terminal.

If a mobile terminal is located in a cell cluster 2, the mobile communication switching center 301 receives uplink signals from base stations of the cell (2,1), the cell (2,2) and the cell (2,3), compensates time delay of the received uplink signal, and generates a cluster 2 signal by adding the time delay-compensated uplink signals by means of the signal adder 420.

In the above example, although two signal adders 410 and 420 are shown to generate the cluster 1 signal and the cluster 2 signal and the time delay compensators 401, 402, 403, 404, 405, 406 and 407 are shown to correspond to the cell base stations managed by the mobile communication switching center 301, the present invention is not limited to this. In actuality, the number of delay compensators may be one or less than the number of cell base stations. However, even in this case, sizes of time delay compensation in the time delay compensators may be in one-to-one correspondence with the cell base stations. In addition, the number of signal adders may be one or less than the number of cell clusters.

On the other hand, although the above example has been illustrated on the basis of the uplink signal, the same concept of the present invention may be applied to a downlink signal. That is, the mobile communication switching center 301 may include signal distributors for distributing a downlink signal, which is received from an upper node, to cell base stations located in a corresponding cluster, and time delay compensators for compensating time delay of downlink signals in consideration of distances from the cell base stations. For example, when a mobile terminal is located in a cell cluster 1, the mobile communication switching center 301 separates the downlink signal of the mobile terminal in the signal distributors so that the downlink signal can be delivered from the upper node to respective base stations of the cell (1,1), the cell (1,2) and the cell (1,3). Thereafter, the mobile communication switching center 301 compensates time delay of separated downlink signals in consideration of time delay with the cell base stations. Thereafter, when the cell base stations send the downlink signals to the mobile terminal, the mobile terminal can receive the downlink signals.

FIG. 5 is an exemplary view of a mobile terminal position information management database maintained by the mobile communication switching center to manage mobility of mobile terminals based on cell clusters according to a preferred embodiment of the present invention.

Referring to FIG. 5, although a mobile terminal may communicate with one cell base station, the mobile terminal may also communicate with two or more cell base stations if the mobile terminal is located in a border of a cell area or a place having overlapped cell areas. A block 1 indicates a case where the mobile terminal communicates with two cell base stations belonging to cell cluster 1. A block 2 indicates a case where the mobile terminal communicates with three cell base stations belonging cell cluster 1 and one cell base station belonging to cell cluster 2. The mobile terminal performs transmit-receive communication with cell cluster signal 1 in the block 1, while performing transmit-receive communication with cell cluster signal 1 and cell cluster signal 2 in the block 2. As can be seen from the above example, in the present invention, by managing the location of the mobile terminal in the unit of cell cluster, the location management can be more easily made than existing mobile information management systems of mobile terminals managed in the unit of cell, and by performing communication with the cell cluster signals as shown in FIG. 4, it is possible to increase quality of transmit/receive signals of the mobile terminals.

FIG. 6 is a view showing a case where a mobile terminal moves in one cell cluster according to a preferred embodiment of the present invention.

FIG. 6 shows that a mobile terminal 601 moves from the cell (1,1) to the cell (1,3) in the same cluster. In this case, the mobile communication switching center confirms that the mobile terminal 601 moved from the cell (1,1) to the cell (1,3) and continues to perform communication with cell cluster signal 1 without performing a separate handover.

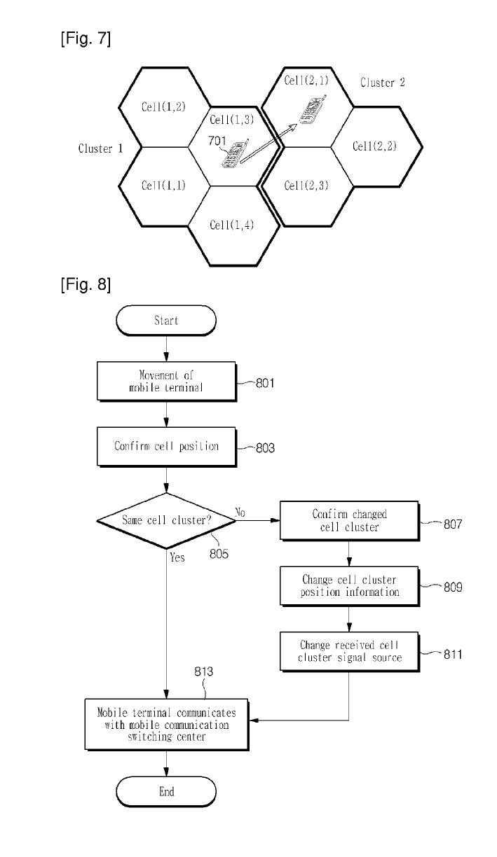

FIG. 7 is a view showing a case where a mobile terminal moves from one cell cluster to another adjacent cell cluster according to a preferred embodiment of the present invention.

FIG. 7 shows that a mobile terminal 701 moves from the cell (1,3) in cluster 1 to the cell (2,1) in cluster 2. In this case, the mobile communication switching center confirms that the mobile terminal 701 moved from the cell (1,3) in cluster 1 to the cell (2,1) in cluster 2 and performs communication with cell cluster signal 1 before the mobile terminal 701 moves and with cell cluster signal 2 after the mobile terminal 701 moves.

FIG. 8 is a flow chart illustrating a process of managing mobility of a mobile terminal in a mobile communication switching center when the mobile terminal moves according to a preferred embodiment of the present invention.

Referring to FIG. 8, a mobile terminal moves between cells (Step 801). The mobile communication switching center confirms a position of a cell at which the mobile terminal is located (Step 803). The mobile communication switching center determines whether or not the mobile terminal is located in the same cell cluster as a previous cell cluster (Step 805). If it is determined that the mobile terminal moved between cell clusters, the process proceeds to Step 807, and otherwise, the process proceeds to Step 813.

At Step 807, the mobile communication switching center confirms a changed cell cluster and changes cell cluster position information for the mobile terminal (Step 809). Thereafter, the mobile communication switching center communicates with the mobile terminal with a cell cluster signal corresponding to the changed cell cluster (Step 811).

At Step 813, the mobile communication switching center continues to communicate with the mobile terminal with an existing cell cluster signal without performing separate location registration change and handover operation.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

1. A method of managing movement of a mobile terminal in the unit of cell cluster in a mobile communication system, comprising the steps of:
forming cell clusters each including at least one cell including a base station communicating with the mobile terminal;
determining a position of the mobile terminal; and
if it is determined that the mobile terminal moves from one cell cluster to another cell cluster, changing location information of the mobile terminal.

2. The method according to claim 1, further comprising the steps of:
receiving uplink signals of the mobile terminal from at least one base station that received the uplink signal of the mobile terminal;
forming a cluster signal by adding the received uplink signals; and
transmitting the cluster signal to an upper node.

3. The method according to claim 2, further comprising the step of:
compensating a difference between signal propagation time delays of the uplink signals due to a difference between distances between the base stations and a mobile communication switching center.

4. The method according to claim 1, wherein communication with the mobile terminal is performed using a cluster signal of the changed cell cluster.

5. The method according to claim 1, wherein the cell clusters are dynamically formed according to the movement of the mobile terminal or change of environments of communication with the mobile terminal.

6. The method according to claim 1, further comprising the steps of:
receiving a downlink signal of the mobile terminal from an upper node;
separating the downlink signal for each of one or more base stations communicating with the mobile terminal; and
transmitting the separated signals to the one or more base stations, respectively, wherein the one or more base stations transmit the separated signals to the mobile terminal

7. A mobile communication system that manages movement of a mobile terminal in the unit of cell cluster, comprising:
a mobile terminal;
one or more base stations that communicates with the mobile terminal; and
a mobile communication switching center that forms cell clusters each including at least one cell including the base stations and manages the movement of the mobile terminal in the unit of cell cluster.

8. The mobile communication system according to claim 7, wherein the mobile communication switching center generates a cell cluster signal by adding uplink signals of the mobile terminal, which are received from the base stations, and transmits the cell cluster signal to an upper node.

9. The mobile communication system according to claim 8, wherein the mobile communication switching center compensates a difference between signal propagation time delays of the uplink signals due to a difference between distances between the base stations and the mobile communication switching center before generating the cell cluster signal by adding the uplink signals.

10. The mobile communication system according to claim 7, wherein the mobile communication switching center changes cell cluster position information of the mobile terminal when the mobile terminal moves from one cell cluster to another cell cluster.

11. The mobile communication system according to claim 10, wherein the mobile communication switching center communicates with the mobile terminal using a cluster signal of the changed cell cluster.

12. The mobile communication system according to claim 7, wherein the mobile communication switching center dynamically forms the cell clusters according to the movement of the mobile terminal or change of environments of communication with the mobile terminal.

13. A mobile communication switching center that communicates with a mobile terminal through one or more base stations included in cell clusters and manages the base stations in the cell clusters, comprising:
one or more time delay compensators that compensate time delays of uplink signals of the mobile terminal, which are received from the base stations; and
one or more signal adders that generate a cluster signal by adding the uplink signals which are time delay-compensated by the time delay compensators, wherein the mobile communication switching center communicates with the mobile terminal using the cluster signal.
